(19) United States
(12) Patent Application Publication
(10) Pub. No.: US 2025/0164642 A1
(43) Pub. Date: May 22, 2025

(54) TIME-OF-FLIGHT SYSTEM AND METHOD

(71) Applicant: Sony Semiconductor Solutions Corporation, Kanagawa (JP)

(72) Inventor: Manuel AMAYA BENITEZ, Brussels (BE)

(73) Assignee: Sony Semiconductor Solutions Corporation, Kanagawa (JP)

(21) Appl. No.: 18/842,415

(22) PCT Filed: Feb. 28, 2023
(86) PCT No.: PCT/EP2023/055033

§ 371 Date: Aug. 29, 2024

(30) Foreign Application Priority Data
Mar. 21, 2022 (EP) 22163262.3

(51) Int. Cl. G01S 17/894; G01S 7/481; G01S 7/4865

(52) U.S. Cl. CPC G01S 17/894; G01S 7/4814; G01S 7/4816; G01S 7/4818; G01S 7/4865

(57) ABSTRACT

A multi-sensing pixel array that comprises, within a multi-layer stacked die, sensing pixels (PIX_R, PIX_G, PIX_B, PIX_D) and an active illumination (PIX_I).

### TECHNICAL FIELD

The present disclosure generally pertains to the field of Time-of-Flight imaging, and in particular to a multi-sensing pixel array and to corresponding devices that implement a multi-sensing pixel array.

### TECHNICAL BACKGROUND

With the continuing development of autonomous driving, traditional 2D cameras are complemented by other camera technologies such as stereo cameras, IR cameras, RADAR, LiDAR, and Time-of-Flight (ToF) cameras.

A Time-of-Flight (ToF) camera is a range imaging camera system that determines the distance of objects by measuring the time of flight of a light signal between the camera and the object for each point of the image. Generally, a ToF camera has an illumination unit (based on LEDs or/and on laser diodes, e.g. VCSEL, Vertical-Cavity Surface-Emitting Laser, Fabry-Perot semiconductor laser, etc.) that illuminates a scene with modulated light. A pixel array in the ToF camera collects the light reflected from the scene and measures phase-shift (iToF, indirect-ToF) or the travelling time of the light (dToF, direct-ToF), and which allows to extract the distance of the objects in the scene.

Currently, acquisitions of the light signal at short distances are typically covered by indirect Time of Flight (iToF) systems and the acquisitions at mid-to-long distances is typically covered by direct Time of Flight (dToF) systems.

In Time-of-Flight (iToF), three-dimensional (3D) images of a scene are captured. These images are also commonly referred to as “depth map”, or “depth image”, wherein each pixel of the image is attributed with a respective depth measurement.

Therefore, it is generally desirable to provide techniques which improve the multi-sensing technology.

### SUMMARY

According to a first aspect the disclosure provides a multi-sensing pixel array that comprises, within a multi-layer stacked die, sensing pixels and an active illumination.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the basic operational principle of Time-of-Flight imaging;

FIG. 2 schematically shows three different stacks that are typically applied in imaging system, an RGB sensor array, a ToF sensor array, and a ToF active illuminator;

FIG. 3 schematically shows an embodiment of a multi-sensing pixel array including active illumination in a top view;

FIG. 4 provides a schematic representation of a cross-sectional view of a multi-sensing pixel array of the embodiments;

FIG. 5 schematically shows an example of a Field of Illumination (Fol) generated by a ToF illuminator;

FIG. 6 schematically shows examples of designing a light channel for a multi-sensing pixel array;

FIG. 7 shows an example of coupling a laser diode to a light channel for a multi-sensing pixel array of the embodiments;

FIG. 8 schematically describes an embodiment of a device that implements a multi-sensing pixel array of the embodiments.

### DETAILED DESCRIPTION OF EMBODIMENTS

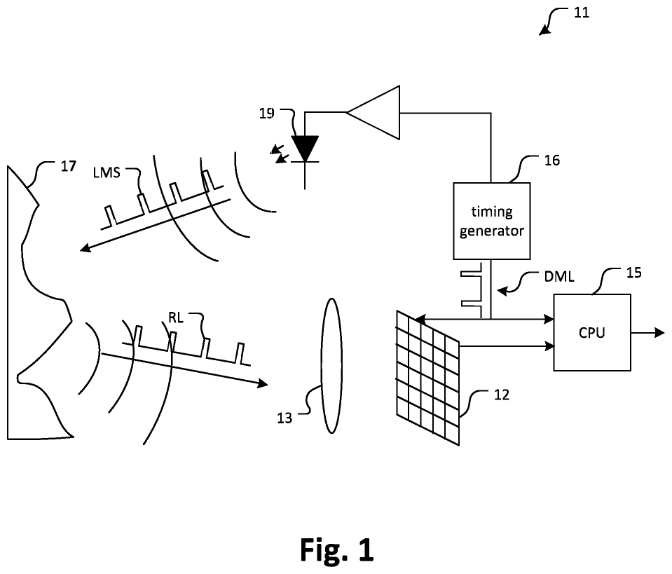

Before a detailed description of the embodiments under reference of FIG. 1, general explanations are made.

The embodiments described below in more detail disclose a multi-sensing pixel array that comprises, within a multi-layer stack die, sensing pixels and an active illumination.

In the multi-sensing pixel array of the embodiments, the sensing pixels and the active illumination may for example be arranged in a single pixel array.

For example, three different dies may be stacked on top of each other to form the multi-sensing pixel array. Each die can be formed by several IC stacks. A multi-layer stack may for example comprise three main components: an optical system, a multi-sensing sensor array (with all its IC stacks, i.e. pixels, and logic) and an illuminator (with all its IC stacks, i.e. cavities, laser driver, controllers, etc). According to some embodiments, the sensing pixels and the active illuminators share a main optical stack.

For example, imaging pixels may be removed from a traditional regular pattern of imaging pixels to instead insert active illumination pass-through optical channels and depth sensing pixels at their place.

The sensing pixels may for example comprise depth sensing pixels.

According to embodiments described below, the depth sensing pixels are ToF pixels.

The depth sensing pixels may for example be ToF pixels. ToF pixels can for example be of different types of technologies, e.g. iToF pixels (CAPD, gated ToF, etc) or dToF pixels (SPAD) or PC pixels (SPAD) or Dynamic-photodiodes (DPD), etc. That is, the ToF pixels may be implemented according to the dToF (direct TOF), iToF (indirect ToF), or PC (photon counting) principles.

In some embodiments, the sensing pixels comprise imaging pixels and depth sensing pixels.

The imaging pixels may for example comprise RGB pixels and/or monochrome pixels and/or infrared pixels (IR), or combinations thereof. Imaging pixels (also called visual pixels) may for example be of the CMOS or CCD type.

The multi-sensing pixel array may for example be implemented using stack-sensing technology.

In this way, sensing and illumination technology is stacked all in one.

For example, the RGBI information may be vertically detected (e.g. by the use of organic pixels).

According to the embodiments, a multi-sensing pixel array comprises a main optical stack, an imaging stack, and an illumination stack.

The main optical stack may for example comprise a main lens, and, optionally, optical filters.

The imaging stack may for example comprise microlenses, a pixel array comprising imaging pixels (RGB and/or monochrome and/or infrared), and ToF pixels. The microlens may create in association with a main optical lens a dedicated field of illumination (FoI) to optimize the amount of active illumination that return from the scene into the ToF pixels.

The imaging stack may further comprise analog circuitry and logic for driving the imaging pixels, and the ToF pixels.

The illumination stack of the multi-sensing pixel array may comprise active illuminators.

The illumination stack of the multi-sensing pixel array may further comprise drivers for driving the active illuminators.

The imaging stack of the multi-sensing pixel array may comprise a respective light channel that is arranged for each respective illumination source, and that is configured to guide out the illumination. For example, the light channels (or “optical channels”) may be located across above stack ICs and may guide the active illumination outside of the package. The optical channel may thus be configured across above-stack ICs to guide the active illumination outside of the stack.

A light channel may be configured as a fiber optical light guide with a step-index profile or with a graded-index profile, or as a single-mode optical fiber.

For each active illuminator, a respective microlens may be arranged to create a field of illumination (Fol) of the illuminator. For example, a microlens may create a dedicated field of illumination per spot. In association with the main optical lens, it may create a desired profile. For example, each illuminator may generate an illumination spot, e.g. a ring., to optimize the amount of active illumination that returns from the scene into the ToF pixels. Otherwise, using the same microlens as the ones used in the imaging pixel would result in the active illumination that returns from the scene falling back in the illumination pixels instead of the ToF ones.

The multi-sensing pixel array may be configured to provide the same field of view (FoV) for the imaging pixels and the depth sensing pixels.

The embodiments also disclose a pixels and cavities control that is configured to activate only those ToF pixels that are actually needed.

The multi-sensing pixel array may for example be implemented in a single IC or in a multi-stack IC.

The multi-sensing pixel array may for example be implemented according to an organic vertical stacking technology.

The coupling of the active illumination with the light channels may for example be performed using a ball lens coupling technology.

The embodiments also disclose a device that implement a multi-sensing pixel array as disclosed here. The device may for example be a smartphone, a laptop, or AR glasses (glasses that realize augmented reality).

The devices may also comprise further circuitry such as a processor, a memory (RAM, ROM or the like), a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g. radar, humidity, light, temperature), etc.

### Operational Principle of a Time-of-Flight Imaging System (ToF)

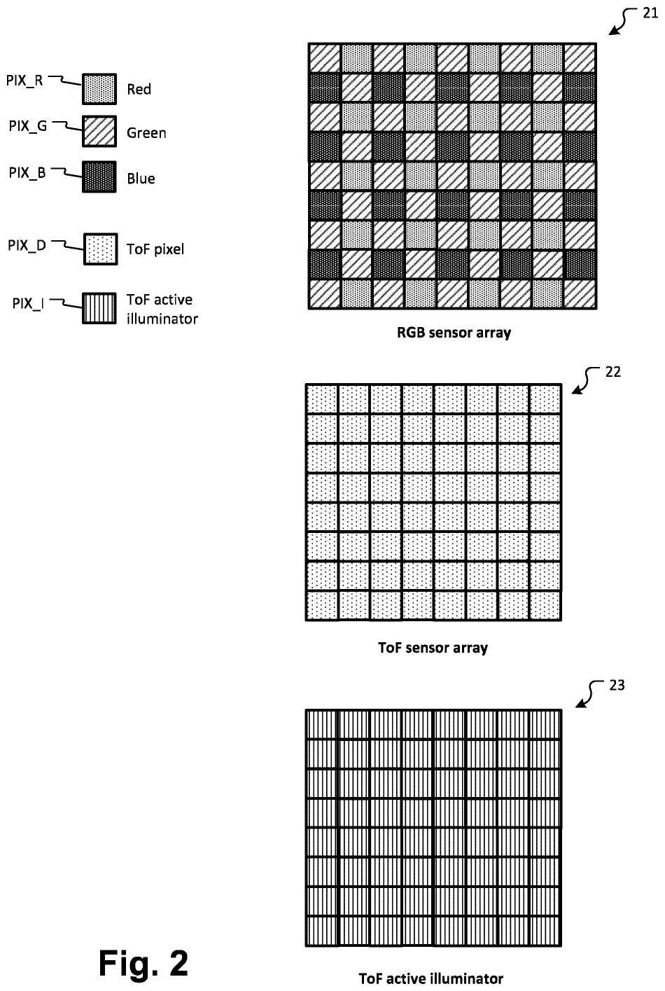

FIG. 1 schematically shows the basic operational principle of an indirect Time-of-Flight imaging system which can be used for depth sensing. The iToF imaging system 11 includes an iToF camera with an imaging sensor 12 having a matrix of pixels and a processor (CPU) 15. A scene 17 is actively illuminated with amplitude-modulated infrared light LMS at a predetermined wavelength using an illumination device 19 (e.g. ToF active illuminator 23 of FIG. 2), for instance with some light pulses of at least one predetermined modulation frequency DML generated by a timing generator 16. The amplitude-modulated infrared light LMS is reflected from objects within the scene 17. A lens 13 collects the reflected light 19 and forms an image of the objects within the scene 17 onto the imaging sensor 12. In indirect Time-of-Flight (iToF) the CPU 15 determines for each pixel a phase delay between the modulated signal DML and the reflected light RL. Based on these correlations a so called in-phase component value (“I value”) and a so called quadrature component value (“Q value”) can be determined (see below for a detailed description) for each pixel.

FIG. 1 describes the principle of a Time-of-Flight imaging system on the example of an indirect Time-of-Flight imaging system. The embodiment described below are, however, not limited to the indirect time Time-of-Flight principle. The depth sensing pixels may also be, for example iToF pixels (CAPD, gated ToF, etc) or dToF pixels (SPAD) or PC pixels (SPAD) or Dynamic-photodiodes (DPD), etc. That is, the ToF pixels may as well be implemented according to the dToF (direct TOF), iToF (indirect ToF), or PC (photon counting) principles.

### Multi-Modal Image Sensors

Imaging systems or devices typically comprise stacks of sensor and illumination technology, e.g. a stack imaging sensors, a stack of ToF sensors, and a stack illuminators. These stacks are normally separated.

FIG. 2 schematically shows three different stacks that are typically applied in imaging system, an RGB sensor array 21, a ToF sensor array 22, and a ToF active illuminator 23. RGB sensor array 21 comprises an array of pixels PIX_R, PIX_G, PIX_B, where PIX_R is a pixel configured to capture red light, PIX_G is a pixel configured to capture green light, and PIX_B is a pixel configured to capture blue light. ToF sensor array 22 comprises an array of ToF pixels PIX_D. ToF active illuminator 23 comprises an array of ToF active illuminators PIX_I. A ToF active illuminator PIX_I may for example be implemented as a vertical-cavity surface-emitting laser (VCSEL), which is a semiconductor laser diode that converts voltage into photons. The photons emitted by ToF active illuminator 23 are directed at a scene, are reflected from the scene and then captured by the ToF sensor array 22 to determine a depth map of the scene. RGBD-fusion techniques may be applied to evaluate the information from RGB sensor array 21 and ToF sensor array 22.

In devices such as smartphones or the like, also other sensing or illumination techniques (not shown in FIG. 2) might be implemented, for example a flash LED, etc.

Using several multiple units in a single device poses difficulties with the space available in the device. For example, in a mobile phone with several sensors, e.g. an RGB sensor, a flash LED, a ToF sensor, ToF active illuminators, and proximity sensor, there will be many holes to carry the sensing devices.

Still further, in smaller devices, e.g. in a pair of glasses using augmented reality (AR), it is not desirable or feasible to have so many separated sensors and illuminators.

Other aspects involved when applying multiple sensing and illumination modalities relate to power consumption. For example, the power per pixel in ToF is very high. The more sensors are applied in a device, the higher is the power consumption.

When there are implementations of transceivers (TX) and receivers (RX) with different optics, also the aspect of disparity (generated by the distance between TX and RX) may play a role. Disparity increases the difficulties in calibration, registration. Disparity may also affect the zoom capabilities of a device.

### All-In-One Stack Sensing

The embodiments described below in more detail provide a multi-sensing pixel array that incorporates an active illumination in it. In these multi-sensing pixel arrays, all sensing and illumination technology is stacked all in one. The embodiments described below in more detail provide an all-in-one approach. They stack three different technologies, namely a stack of RGB sensors, a stack of ToF sensors, and a stack of illuminators.

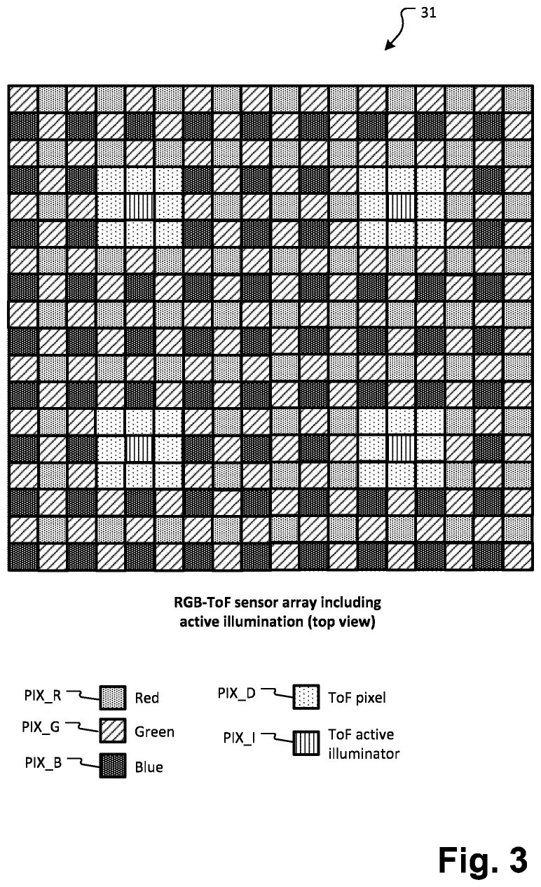

FIG. 3 schematically shows an embodiment of a multi-sensing pixel array including active illumination in a top view. The multi-sensing pixel array is implemented as an RGB-ToF sensor array 31 including active illumination for generating a sparse depthmap. RGB-ToF sensor array 31 comprises an array of pixels PIX_R, PIX_G, PIX_B, and PIX_D, where PIX_R is a pixel configured to capture red light, PIX_G is a pixel configured to capture green light, and PIX_B is a pixel configured to capture blue light, and PIX_D is a ToF pixel. In each quadrant of the RGB-ToF sensor array 31 a group of eight ToF pixels is arranged, in the center of which is located a ToF active illuminator PIX_I. That is, in the active illuminator pixel PIX_I in the center of the of eight ToF pixels PIX_D, an aperture is provided in the multi-sensing pixel layer through which active light generated in a below active illumination stack (e.g. VCSEL) gets out of the multi-stack die as described in more detail in the embodiments below. As it is explained in more detail in the embodiments described below, there are different ways (e.g. simple hole with lateral barriers, a fiber optic like configuration, etc.) to guide the light from the active illumination stack through the above die stacks.

The ToF pixels PIX_D can be of many different types of technologies, e.g. iToF pixels (CAPD, gated ToF, etc) or dToF pixels (SPAD) or PC pixels (SPAD), etc.

In the design of FIG. 3, imaging pixels are thus removed to insert active illumination and ToF pixels. It should, however, be noted that the ToF pixel intensity values provided by the ToF pixels PIX_D allow to compensate for the RGB pixels that have been removed from the sensor to accommodate the ToF pixels PIX_D.

In a multi-sensing pixel array including active illumination such as RGB-ToF sensor array 31 of FIG. 3, it is not necessary to have a regular size of the different pixels and/or illumination spots.

A multi-sensing pixel array technology such as the one described in FIG. 3 above can also be applied to stack-sensing, i.e. the RGBI information is vertically detected (e.g. by the use of organic pixels).

It should be noted that the multi-sensing pixel array technology is not limited to the RGB-ToF type. All possible configurations are possible. For example, the ToF active illumination surrounded by the ToF pixels might be surrounded by IR imaging pixels and/or IR pixels.

There are use cases for the pixel array of FIG. 3 such as object identification, SLAM, etc. which use RGBD-fusion, where only a few ToF pixels (sparse depthmaps) are needed.

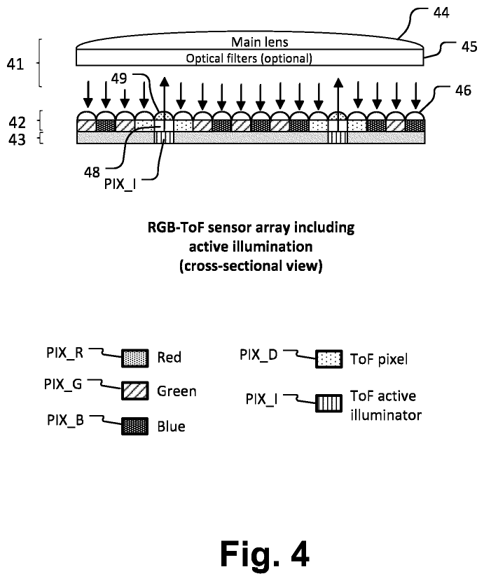

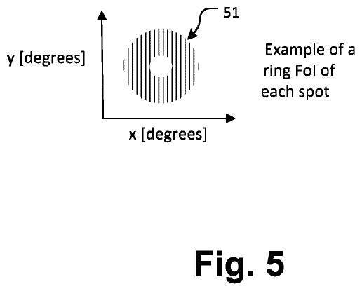

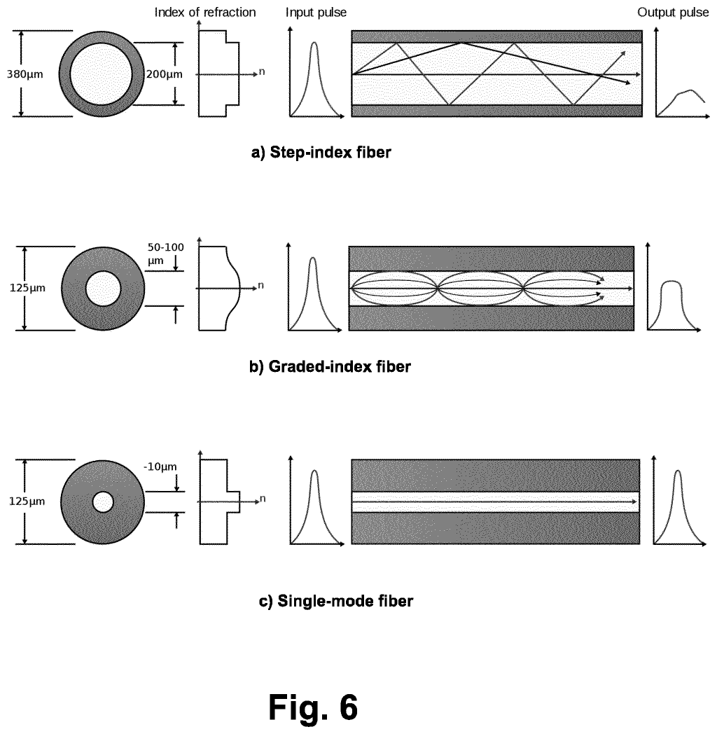

FIG. 4 provides a schematic representation of a cross-sectional view of a multi-sensing pixel array of the embodiments. The multi-sensing pixel array comprises a main optical stack 41, an RGB-ToF stack 42, and an illumination stack 43. The main optical stack 41 comprises a main lens 44 and optional optical filters 45. The RGB-ToF stack 42 comprises microlenses 45 and optional optical filters (not shown), a pixel array comprising RGB pixels PIX_R, PIX_G, PIX_B, and ToF pixels PIX_D, and analog circuitry and logic for driving these pixels. The illumination stack 43 comprises ToF active illuminators PIX_I as illumination sources that emit light (as indicated by the vertical upward-pointing arrow) and respective drivers (not shown) for driving the illumination sources 47. A light channel 48 in the illumination stack 43 that is arranged for each respective illumination source PIX_I guides out the illumination. The light channels (or “optical channels”) across above stack ICs guide the active illumination outside of the package. The light channels can for example be implemented in different ways, e.g. as a hole with lateral IR barriers, or a fiber optic (filling the core with a material with higher refraction index n than the surrounding as shown in FIG. 6 below). For each ToF active illuminator PIX_I, a respective microlens 49 is arranged to create the field of illumination (Fol) of the illuminator. The microlens 49 creates a dedicated field of illumination per spot, so the light reflected in the scene does not fall back in the PIX_I, but in the surrounding PIX_D. In association with the main optical lens, it creates the desired profile. For example, each illuminator may generate an illumination spot (e.g. a ring) as shown in FIG. 5 below. As indicated by the dotted pattern, these microlenses 49 that create the Field of Illumination are different from the microlenses 46 that focus the light on the RGB-ToF pixels R, PIX_G, PIX_B, and PIX_D.

The multi-sensing pixel array of FIG. 4 thus shares the main optical stack 41 (FoV, Field of View) for the sensors and active illuminators. A multi-sensing pixel array such as described in FIG. 4 may thus provide the same FoV for RGB and ToF. It thus simplifies calibration and post processing.

It should be noted that in the multi-sensing pixel array of FIG. 4 the active-light source is located in a below-die stack, i.e it is not located in the same die stack than the pixel sensor array.

The multi-sensing pixel array as described in FIG. 4 above uses of an optical channel across above-stack ICs to guide the active illumination outside of the stack. It creates a dedicated Fol (field of illumination) per spot, so that in association with the main optical lens, it creates the desired profile (e.g. a ring shape as described in FIG. 5 below).

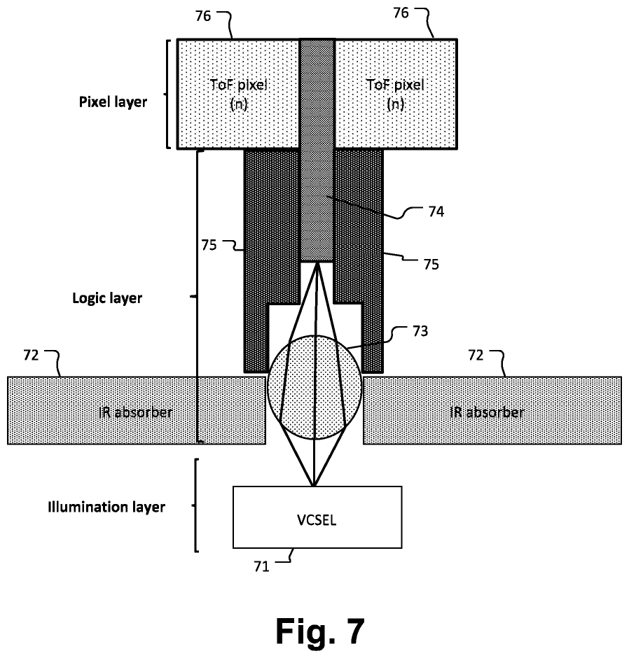

The coupling of the laser illuminators PIX_I with the light channels 48 can be done in different ways. For example, a ball lens technology (see FIG. 7 and corresponding description) may be used for this coupling of the laser illuminators PIX_I with the light channels 48.

It should be noted that in the example of FIG. 4, for the purpose of simplification, a 3-layer stack case is shown. In other embodiments, however, there may be more layers. The pixel stack may comprise multiple sub-stacks (pixels, analog and digital), the illumination stack may comprise several sub-stacks (laser cavities, analog and maybe logic), and so on. FIG. 5 schematically shows an example of a Field of Illumination (FoI) generated by a ToF illuminator. The diagram shows on the abscissa the x dimension in degrees and on the ordinate the y dimension in degrees. A ToF illuminator (PIX_I in FIGS. 3 and 4) generates a ring Fol 51 of each spot.

It should however be noted that the ToF pixel arrangement can be changed from spots to other configurations. The pixel sensor technology can for example be homogenous or heterogeneous. To confine the illumination inside the light channel so it avoids the illumination to impact in the surrounding ToF pixels, different approaches can be applied, for example optical barriers surrounding the light channel, small fiber-optic-like channels (by creating a reflection index step between the channel and the surrounding pixels), etc.

Still further, other aspects may be applied in the embodiments. For example, a pixels and cavities control may be provided. That is, the pixels and cavities control activates only those ToF pixels that are actually needed so that the light is emitted only when it is needed.

As only sparse arrangement of ToF points are needed according to the multi-sensing pixel array of FIGS. 3 and 4, the power consumption is reduced. Still further, with a multi-sensing pixel array as described in FIGS. 3 and 4, the transceiver (TX) and receiver (RX) are implemented on a single stack so that disparity is reduced.

Still further, parallax issues can be canceled for ToF. As the active ToF illuminator and the ToF pixels share the same lens, optical defects are compensated. This also allows to optically zoom in/out with ToF.

Still further, a multi-sensing pixel array such as described in FIGS. 3 and 4 does not require compatibility between technologies. This is beneficial because current lasers and sensors typically use different technologies. This is helpful, because with a design such as described in FIG. 4, different suppliers can provide the different stacks.

Still further, a multi-sensing pixel array such as described in FIGS. 3 and 4 allows to reduce the number of holes in a device from 3 to 1. This is beneficial for small devices and cost reduction. The multi-sensing pixel array does not require too many holes which provide an interface between the device and the outside. This is particularly beneficial as it is not desirable/feasible to have many separated sensors/illuminators in small devices such as AR glasses.

Still further, a multi-sensing pixel array such as described in FIGS. 3 and 4 allows to reduce the space in the device that is required for the sensors. To have a sensing device, e.g. in a mobile phone, several RGB sensors, a flash LED, a ToF sensor and active illuminators may be fitted into the device without requirement of a lot of space. This is in particular helpful for smaller devices, e.g. a pair of glasses using AR.

Still further, any potential reflection (inside out) of the active light at the main optical lens in the ToF pixels can be detected with practically zero delay, so it can be easily removed.

Other benefits of a multi-sensing pixel array such as described in FIGS. 3 and 4 is the optimal use of the sensor array and the illuminator. For example, it is not necessary to have a full array of sensors to locate the positions of the spots. The illumination can be as efficient and intense as in a spot illuminator. Further, there is no need to have extra active pixels to cope with the displacement of the dots due to the disparity.

The multi-sensing pixel array as described in FIGS. 3 and 4 may for example be implemented in a single IC using known stack illuminator technology (driver under cavities). The ToF pixels may be implemented according to the dToF (direct TOF), iToF (indirect ToF), or PC (photon counting) principles. The multi-sensing pixel array as described in FIGS. 3 and 4 thus connects the technology of dToF, PC and PC-ToF with the stack illuminator technology. Multi-sensing pixel array technologies as known from the stack illuminator technology may for example be used to implement a multi-sensing pixel array according to the embodiments. For example, organic vertical stack pixels such as disclosed in US 2021/0043687 A1 may be applied. Here, an organic photoelectric conversion layer absorbs only lights in the visible light region and generates signal charges corresponding to lights of the respective color components of R (red) component, G (green) component, and B (blue) component. An IR-component light in the infrared region transmits through the organic photoelectric conversion layer. This allows for including RGB and IR pixels into a single stack.

FIG. 6 schematically shows examples of designing the light channels (48 in FIG. 4) for a multi-sensing pixel array. Three examples are provided in FIG. 6 in which the light channels are configured by fiber optical light guides.

According to a first example a), an optical fiber with step-index profile is used. A step-index profile is a refractive index profile characterized by a uniform refractive index within the core and a sharp decrease in refractive index at the core-cladding interface so that the cladding is of a lower refractive index. The light channel of this example is configured in a circular shape with an inner diameter of 200 mm and an outer diameter of 380 mm. The inner material of the light channel has a larger index of refraction n than the wall material. The index of refraction has a step-like shape. An input pulse has a pulse profile as schematically shown in the profile diagram at the input of the light channel, with a maximum in the center of the profile and decreasing towards the edges. When passing the light channel, the input pulse is reflected at the transitions from the inner material to the wall material. Different portions of the input pulse are reflected at different angles of reflection which results in a dampening of the input pulse. The resulting output pulse has a profile as schematically shown in the pulse diagram at the output of the light channel. The maximum in the output pulse profile is less pronounced that in the input pulse profile

According to a second example b), a graded-index fiber is used. A graded-index is an optical fiber whose core has a refractive index that decreases with increasing radial distance from the optical axis of the fiber. The light channel of this example is configured in a circular shape with an inner diameter of 50-100 mm and an outer diameter of 125 mm. The index of refraction does not have a step-like shape but gradually increases towards the center of the light channel and stays substantially constant withing the region of the inner diameter. An input pulse has a pulse profile as schematically shown in the profile diagram at the input of the light channel, with a maximum in the center of the profile and decreasing towards the edges. When passing the light channel, the input pulse is gradually reflected by the refraction index profile as schematically shown in the figure. The resulting output pulse has a profile as schematically shown in the pulse diagram at the output of the light channel. With the graded index fiber, the dampening of the pulse maximum is less pronounced than in example a) of the step index fiber.

According to a third example c), a single-mode optical fiber (SMF) is used. A single-mode optical fiber, also known as fundamental-mode or mono-mode fiber, is an optical fiber designed to carry only a single mode of light-the transverse mode. The light channel of this example c) is configured in a circular shape with an inner diameter of less than 10 mm and an outer diameter of 125 mm. The inner material of the light channel has a larger index of refraction n than the wall material. As in example a), the index of refraction has a step-like shape. However, due to the narrow configuration, only a single mode of the laser illuminator is passed by the light channel. An input pulse has a pulse profile as schematically shown in the profile diagram at the input of the light channel, with a maximum in the center of the profile and decreasing towards the edges. The single mode is transmitted by the light channel substantially without losses. The resulting output pulse has a profile as schematically shown in the pulse diagram at the output of the light channel. The output pulse profile is substantially the same as the input pulse profile.

FIG. 7 shows an example of coupling a laser diode to a light channel for a multi-sensing pixel array of the embodiments. The example makes use of the ball lens coupling technology. The multi-sensing pixel array comprises an illumination layer, a logic layer and a pixel layer. The illumination layer comprises a VCSEL 71 which is configured to generate laser light that is directed towards to logic layer and pixel layer. Absorbers 72 in the logic layer guide the light towards a ball lens 73 which focuses the light onto an optical fiber 74. The optical fiber 74 is fixed in a sleeve 75 which acts as mechanical holder. Two ToF pixels 76 are arranged in the pixel layer. The optical fiber 74 passes between the two ToF pixels 76 and guided the laser light of the VCSEL to the outside. Ball lens 73 has a short focal length and a large aperture which makes it specifically well-suited for coupling the laser light to the optical fiber has several optical properties. The mechanical symmetry of the ball lens 73 also makes it easy to align and center. Ball lens 73 inside sleeve 75 at the end of optical fiber 74 allows for self-centering it for easy alignment.

Sleeve 75 which acts as mechanical holder may for example be a dielectric.

In the example of FIG. 7, a ball lens coupling technique is used for coupling the laser light to the optical fiber. It should, however, be noted that, in alternative embodiments, other coupling techniques such as butt coupling may be applied.

### Implementation

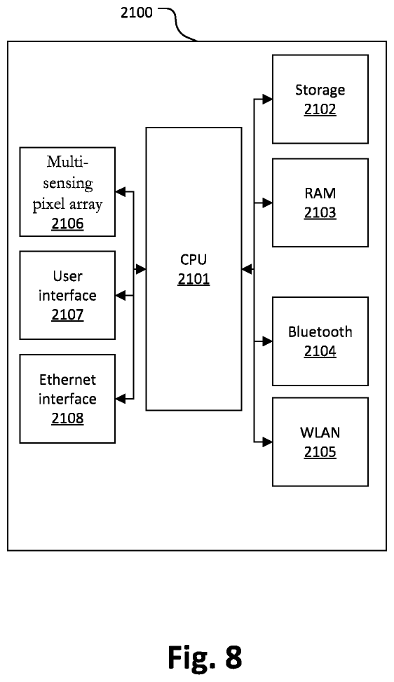

FIG. 8 schematically describes an embodiment of a device that makes us of a multi-sensing pixel array as described in the embodiments above. The electronic device 2100 may further implement all other processes of a standard RGB, IR, iToF, dToF, PC, or spot ToF system. The electronic device 2100 comprises a CPU 1201 as processor. The electronic device 2100 further comprises a multi-sensing pixel array 2106 connected to the processor 2101. The processor 2101 may for example implement performing an RGB and depth measurement. The electronic device 2100 further comprises a user interface 2107 that is connected to the processor 2101. This user interface 2107 acts as a man-machine interface and enables a dialogue between an administrator and the electronic system. For example, an administrator may make configurations to the system using this user interface 2107. The electronic device 2100 further comprises a Bluetooth interface 2104, a WLAN interface 2105, and an Ethernet interface 2108. These units 2104, 2105 act as I/O interfaces for data communication with external devices. For example, other devices with Ethernet, WLAN or Bluetooth connection may be coupled to the processor 2101 via these interfaces 2104, 2105, and 2108. The electronic device 2100 further comprises a data storage 2102, and a data memory 2103 (here a RAM). The data storage 2102 is arranged as a long-term storage, e.g. for storing parameters for one or more use-cases, for recording sensor data obtained from the multi-sensing pixel array 2106, or the like. The data memory 2103 is arranged to temporarily store or cache data or computer instructions for processing by the processor 2101.

It should be noted that the description above is only an example configuration. Alternative configurations may be implemented with additional or other units, sensors, or the like.

It should also be noted that the division of the device of FIG. 8 into units is only made for illustration purposes and that the present disclosure is not limited to any specific division of functions in specific units.

It should further be noted that the embodiments are not constrained by a particular detection technique. The RGB, IR, iToF, dToF, PC and SPAD technologies are only described as an example.

It should also be recognized that the embodiments describe methods with an exemplary ordering of method steps. The specific ordering of method steps is, however, given for illustrative purposes only and should not be construed as binding.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below:
(1) A multi-sensing pixel array that comprises, within a multi-layer stacked die, sensing pixels (PIX_R, PIX_G, PIX_B, PIX_D) and an active illumination (PIX_I).
(2) The multi-sensing pixel array of (1), in which the sensing pixels (PIX_R, PIX_G, PIX_B, PIX_D) comprise depth sensing pixels (PIX_D).
(3) The multi-sensing pixel array of (1) or (2), in which the sensing pixels (PIX_R, PIX_G, PIX_B, PIX_D) comprise imaging pixels (PIX_R, PIX_G, PIX_B) and depth sensing pixels (PIX_D).
(4) The multi-sensing pixel array of any one of (1) or (3), in which the sensing pixels (PIX_R, PIX_G, PIX_B, PIX_D) and the active illumination (PIX_I) are arranged in a single pixel array.
(5) The multi-sensing pixel array of any one of (1) or (4), in which the sensing pixels (PIX_R, PIX_G, PIX_B, PIX_D) and the active illuminators (PIX_I) share a main optical stack (41).
(6) The multi-sensing pixel array of any one of (1) to (5), in which the imaging pixels comprise RGB pixels (PIX_R, PIX_G, PIX_B) or IR pixels, or combinations thereof.
(7) The multi-sensing pixel array of any one of (1) to (6), in which the depth sensing pixels comprise ToF pixels (PIX_D).
(8) The multi-sensing pixel array of any one of (1) to (7), comprising a main optical stack (41), an imaging stack (42), and an illumination stack (43).
(9) The multi-sensing pixel array of (8), wherein the main optical stack (41) comprises a main lens (44).
(10) The multi-sensing pixel array of (8) or (9), wherein the imaging stack (42) comprises microlenses (45), a pixel array comprising RGB pixels (PIX_R, PIX_G, PIX_B), and ToF pixels (PIX_D).
(11) The multi-sensing pixel array of any one of (8) to (10), wherein the illumination stack (43) comprises active illuminators (PIX_I).
(12) The multi-sensing pixel array of any one of (1) to (11), wherein the illumination stack (43) comprises a respective light channel (48) that is arranged for each respective illumination source (PIX_I) and that is configured to guide out the illumination.
(13) The multi-sensing pixel array of any one of (1) to (12), in which a light channel (48) is configured as a fiber optical light guide with a step-index profile or with a graded-index profile, or as a single-mode optical fiber.
(14) The multi-sensing pixel array of any one of (1) to (13), wherein, for each active illuminator (PIX_I), a respective microlens (49) is arranged to create a field of illumination (FoI) of the illuminator.
(15) The multi-sensing pixel array of any one of (1) to (14), configured to provide the same field of view (FoV) for the imaging pixels (PIX_R, PIX_G, PIX_B) and the depth sensing pixels (PIX_D).
(16) The multi-sensing pixel array of any one of (1) to (15), in which a pixels and cavities control is provided that is configured to activate only those ToF pixels that are actually needed.
(17) The multi-sensing pixel array of any one of (1) to (16), wherein the multi-sensing pixel array is implemented in a single IC.
(18) The multi-sensing pixel array of any one of (1) to (17), wherein the multi-sensing pixel array is implemented according to an organic vertical stacking technology.
(19) The multi-sensing pixel array of any one of (1) to (18), in which the coupling of the active illumination (PIX_I) with the light channels (48) is performed using a ball lens coupling technology.

1. A multi-sensing pixel array that comprises, within a multi-layer stacked die, sensing pixels and an active illumination.

2. The multi-sensing pixel array of claim 1, in which the sensing pixels comprise depth sensing pixels.

3. The multi-sensing pixel array of claim 1, in which the sensing pixels comprise imaging pixels and depth sensing pixels.

4. The multi-sensing pixel array of claim 1, in which the sensing pixels and the active illumination are arranged in a single pixel array.

5. The multi-sensing pixel array of claim 1, in which the sensing pixels and the active illuminators share a main optical stack.

6. The multi-sensing pixel array of claim 1, in which the imaging pixels comprise RGB pixels or IR pixels, or combinations thereof.

7. The multi-sensing pixel array of claim 1, in which the depth sensing pixels comprise ToF pixels.

8. The multi-sensing pixel array of claim 1, comprising a main optical stack, an imaging stack, and an illumination stack.

9. The multi-sensing pixel array of claim 8, wherein the main optical stack comprises a main lens.

10. The multi-sensing pixel array of claim 8, wherein the imaging stack comprises microlenses, a pixel array comprising RGB pixels, and ToF pixels.

11. The multi-sensing pixel array of claim 8, wherein the illumination stack comprises active illuminators.

12. The multi-sensing pixel array of claim 1, wherein the illumination stack comprises a respective light channel that is arranged for each respective illumination source and that is configured to guide out the illumination.

13. The multi-sensing pixel array of claim 1, in which a light channel is configured as a fiber optical light guide with a step-index profile or with a graded-index profile, or as a single-mode optical fiber.

14. The multi-sensing pixel array of claim 1, wherein, for each active illuminator, a respective microlens is arranged to create a field of illumination of the illuminator.

15. The multi-sensing pixel array of claim 1, configured to provide the same field of view for the imaging pixels and the depth sensing pixels.

16. The multi-sensing pixel array of claim 1, in which a pixels and cavities control is provided that is configured to activate only those ToF pixels that are actually needed.

17. The multi-sensing pixel array of claim 1, wherein the multi-sensing pixel array is implemented in a single IC.

18. The multi-sensing pixel array of claim 1, wherein the multi-sensing pixel array is implemented according to an organic vertical stacking technology.

19. The multi-sensing pixel array of claim 1, in which the coupling of the active illumination with the light channels is performed using a ball lens coupling technology.
